(19) United States
(12) Patent Application Publication
(10) Pub. No.: US 2014/0060725 A1
(43) Pub. Date: Mar. 6, 2014

(54) MANUFACTURING METHOD OF LIQUID CRYSTAL DISPLAY DEVICE

(71) Applicant: Japan Display Inc., Minato-ku (JP)

(72) Inventors: Megumi ISE, Tokyo (JP); Nobuko Fukuoka, Tokyo (JP); Yoshiyuki Ono, Tokyo (JP); Fumihisa Ishikawa, Tokyo (JP)

(73) Assignee: Japan Display Inc., Minato-ku (JP)

(21) Appl. No.: 14/016,551

(22) Filed: Sep. 3, 2013

(30) Foreign Application Priority Data
Sep. 3, 2012 (JP) 2012-193213

(51) Int. Cl. G02F 1/13

(52) U.S. Cl. CPC G02F 1/1306
USPC 156/145

(57) ABSTRACT

A manufacturing method of a liquid crystal display device, includes forming sealants on a first substrate, forming the dummy sealants including forming a first straight portion from a first start point and then, forming a second straight portion, thereby forming a first dummy sealant having a first end point overlapping the first start point, and forming a third straight portion from a second start point and then, forming a fourth straight portion, thereby forming a second dummy sealant having a second end point overlapping the second start point, and forming a first air inlet between the first dummy sealant and the second dummy sealant, dropping a liquid crystal material, and disposing a second substrate in a pressure-reduced environment.

### CROSS-REFERENCE TO RELATED APPLICATIONS

This application is based upon and claims the benefit of priority from Japanese Patent Application No. 2012-193213, filed Sep. 3, 2012, the entire contents of which are incorporated herein by reference.

### FIELD

Embodiments described herein relate generally to a method of manufacturing a liquid crystal display device.

### BACKGROUND

By virtue of such advantageous features as light weight, small thickness and low power consumption, liquid crystal display devices have been used as display devices of OA equipment such as personal computers, TVs, mobile terminal devices, car navigation devices, and game machines.

As one of methods of manufacturing liquid crystal display panels, one drop filling (ODF) method has been put to practical use. In the ODF method, a frame-shaped sealant is formed on one of substrates, and a liquid crystal material is dropped in an inside surrounded by the sealant. In a vacuum state, the other substrate is laid over the one substrate. The resultant structure is then opened to an atmospheric pressure, and thereby the paired substrates are pressurized under the atmospheric pressure, and a liquid crystal panel with a desired cell gap is formed.

As regards the ODF method, there has been proposed a method in which a dummy sealant is disposed on the outermost periphery of the paired substrates. Methods of disposing the dummy sealant are generally classified into a close type in which a continuous and frame-shaped dummy sealant is formed, and an open type in which a dummy sealant is formed with an air inlet being secured.

In the case of the close type, an inside surrounded by the dummy sealant is evacuated when a pair of substrates are attached in a vacuum state. Thus, when the resultant structure is opened to an atmospheric pressure, the paired substrates are pressurized due to a pressure difference between the inside and outside of the dummy sealant. At this time, since a dropped liquid crystal material is sealed in an inside region of each sealant and a plurality of columnar spacers are disposed in the inside region, the inside region properly collapses. Meanwhile, since the outside region of the sealant is in a vacuum state and the number of spacers is smaller in the outside region than in the inside region, the outside region tends to excessively collapse when the atmospheric pressure is applied. If such a phenomenon extends to the vicinity of the sealant, the cell gap in the vicinity of the sealant becomes smaller than a desired value, even in the inside region of the sealant.

On the other hand, in the case of the open type, since atmospheric air is introduced via the air inlet when the structure is opened to the atmospheric pressure, the paired substrates are pressurized by a pressure difference in the inside of each sealant. However, in the outside region of the sealant, since the pressure difference is small, the force of pressurizing the paired substrates is weak. Thus, although the outside region of the sealant does not excessively collapse, there may be a case in which the inside region of the sealant cannot be properly collapsed. In particular, in a peripheral region of the air inlet, since atmospheric air is instantaneously introduced and there is substantially no pressure difference, the inside region of the sealant does not sufficiently collapse (or the vicinity of the sealant is raised), and the cell gap becomes greater than a desired value.

Such non-uniformity in cell gap leads to degradation in display quality, such as non-uniformity in display. Therefore, there has been a demand for improvement of the uniformity in cell gap.

### BRIEF DESCRIPTION OF THE DRAWINGS

FIG. 1 is a plan view which schematically illustrates the structure of a liquid crystal display device according to an embodiment.

FIG. 2 is a view for describing a manufacturing method of a liquid crystal display panel shown in FIG. 1, FIG. 2 being a plan view for describing a fabrication step of preparing a first mother-substrate.

FIG. 3 is a view for describing the manufacturing method of the liquid crystal display panel shown in FIG. 1, FIG. 3 being a plan view for describing a fabrication step of forming sealants and dummy sealants.

FIG. 4 is a view for describing the manufacturing method of the liquid crystal display panel shown in FIG. 1, FIG. 4 being a cross-sectional view for describing a fabrication step of dropping a liquid crystal material on the first mother-substrate.

FIG. 5 is a view for describing the manufacturing method of the liquid crystal display panel shown in FIG. 1, FIG. 5 being a cross-sectional view for describing a fabrication step of attaching the first mother-substrate and a second mother-substrate.

FIG. 6 is a view for describing the manufacturing method of the liquid crystal display panel shown in FIG. 1, FIG. 6 being a plan view for describing the state of regions between the first mother-substrate and second mother-substrate at a time when the pressure is restored to an atmospheric pressure.

FIG. 7 is a view for describing the manufacturing method of the liquid crystal display panel shown in FIG. 1, FIG. 7 being a cross-sectional view for describing a fabrication step of pressurizing the first mother-substrate and second mother-substrate.

FIG. 8 is a view for describing the manufacturing method of the liquid crystal display panel shown in FIG. 1, FIG. 8 being a cross-sectional view for describing a fabrication step of taking out a liquid crystal display panel by cutting the first mother-substrate and second mother-substrate.

FIG. 9 is a plan view illustrating another shape example of the sealants and dummy sealants.

### DETAILED DESCRIPTION

In general, according to one embodiment, a manufacturing method of a liquid crystal display device, includes: forming sealants each having a closed loop shape surrounding each of a plurality of active areas on a first substrate; forming dummy sealants each located on an outside of the plurality of active areas and having a closed loop shape at a plurality of end portions of the first substrate, said forming the dummy sealants including forming a first straight portion from a first start point and then, with a U-turn being made, forming a second straight portion which is spaced apart from the first straight portion and is parallel to the first straight portion, thereby forming a first dummy sealant having a first end point overlapping the first start point, and forming a third straight portion from a second start point and then, with a U-turn being made, forming a fourth straight portion which is spaced apart from the third straight portion and is parallel to the third straight portion, thereby forming a second dummy sealant having a second end point overlapping the second start point, and forming a first air inlet between the first dummy sealant and the second dummy sealant; dropping a liquid crystal material in an inside surrounded by each of the sealants; and disposing a second substrate such that the second substrate is opposed to each of regions surrounded by the sealants and the dummy sealants of the first substrate in a pressure-reduced environment, and subsequently pressurizing the first substrate and the second substrate by an atmospheric pressure, introducing atmospheric air from the first air inlet into a space between the first substrate and the second substrate, and curing the sealants and the dummy sealants.

According to another embodiment, a manufacturing method of a liquid crystal display device, includes: forming sealants each having a closed loop shape surrounding each of a plurality of active areas on a first substrate; forming dummy sealants each located on an outside of the plurality of active areas and having a closed loop shape at a plurality of end portions of the first substrate, said forming the dummy sealants including forming a first dummy sealant including a first straight portion, a second straight portion which is spaced apart from the first straight portion and is parallel to the first straight portion, a first curved portion connecting one end portion of the first straight portion and one end portion of the second straight portion, and a second curved portion connecting the other end portion of the first straight portion and the other end portion of the second straight portion, and forming a second dummy sealant including a third straight portion, a fourth straight portion which is spaced apart from the third straight portion and is parallel to the third straight portion, a third curved portion connecting one end portion of the third straight portion and one end portion of the fourth straight portion, and a fourth curved portion connecting the other end portion of the third straight portion and the other end portion of the fourth straight portion, and forming a first air inlet between the second curved portion and the third curved portion; dropping a liquid crystal material in an inside surrounded by each of the sealants; and disposing a second substrate such that the second substrate is opposed to each of regions surrounded by the sealants and the dummy sealants of the first substrate in a pressure-reduced environment, and subsequently pressurizing the first substrate and the second substrate by an atmospheric pressure, introducing atmospheric air from the first air inlet into a space between the first substrate and the second substrate, and curing the sealants and the dummy sealants.

According to another embodiment, a manufacturing method of a liquid crystal display device, includes: forming sealants each having a closed loop shape on a first substrate; forming dummy sealants each having a closed loop shape at a plurality of end portions of the first substrate, said forming the dummy sealants including forming at a first end portion a first dummy sealant including a first straight portion, a second straight portion which is spaced apart from the first straight portion and is parallel to the first straight portion, a first curved portion connecting one end portion of the first straight portion and one end portion of the second straight portion, and a second curved portion connecting the other end portion of the first straight portion and the other end portion of the second straight portion, and forming at a second end portion, which is perpendicular to the first end portion, a second dummy sealant including a third straight portion, a fourth straight portion which is spaced apart from the third straight portion and is parallel to the third straight portion, a third curved portion connecting one end portion of the third straight portion and one end portion of the fourth straight portion, and a fourth curved portion connecting the other end portion of the third straight portion and the other end portion of the fourth straight portion, the second dummy sealant being spaced apart from the first dummy sealant; dropping a liquid crystal material in an inside surrounded by each of the sealants; and disposing a second substrate such that the second substrate is opposed to each of regions surrounded by the sealants and the dummy sealants of the first substrate in a pressure-reduced environment, and subsequently pressurizing the first substrate and the second substrate by an atmospheric pressure, introducing atmospheric air into a space between the first substrate and the second substrate, and curing the sealants and the dummy sealants.

An embodiment will be described hereinafter with reference to the accompanying drawings. In the drawings, structural elements having the same or similar functions are denoted by like reference numerals, and an overlapping description is omitted.

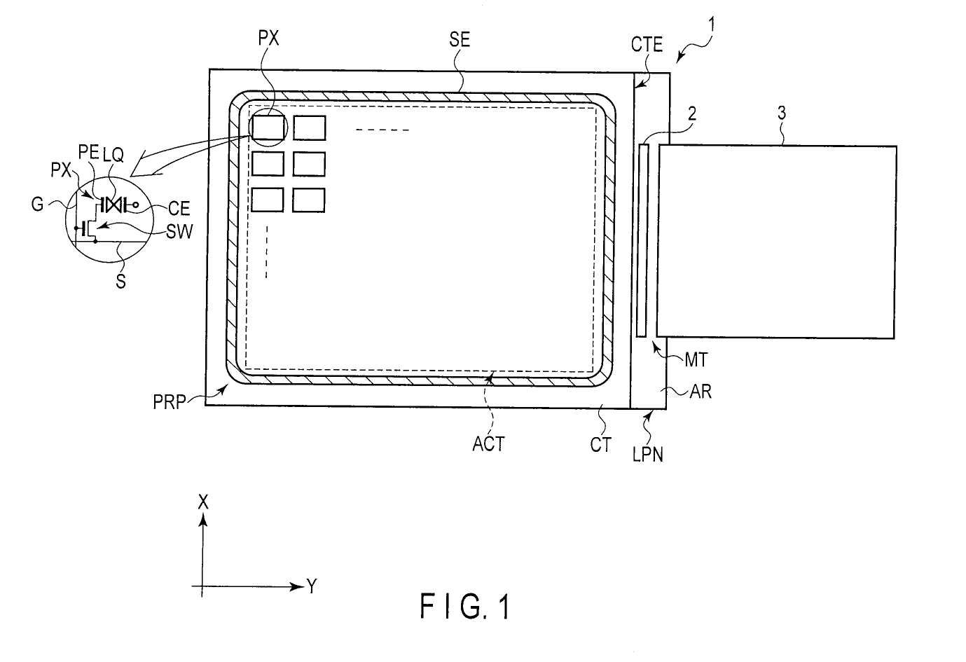

FIG. 1 is a plan view which schematically shows the structure of a liquid crystal display device 1 according to an embodiment.

Specifically, the liquid crystal display device 1 includes an active-matrix-type liquid crystal display panel LPN, and a signal supply source such as a driving IC chip 2 and a flexible wiring board 3 which are connected to the liquid crystal display panel LPN.

The liquid crystal display panel LPN is configured to include an array substrate AR as a first substrate, a counter-substrate CT as a second substrate which is disposed to be opposed to the array substrate AR, and a liquid crystal layer LQ which is held between the array substrate AR and the counter-substrate CT. The array substrate AR and the counter-substrate CT are attached by a sealant SE in a state in which a predetermined cell gap is formed between the array substrate AR and the counter-substrate CT. The cell gap is formed by columnar spacers (not shown) which are formed on the array substrate AR or counter-substrate CT. The liquid crystal layer LQ is held in an inside surrounded by the sealant SE in the cell gap between the array substrate AR and the counter-substrate CT.

The liquid crystal display panel LPN includes an active area ACT, which displays an image, in the inside surrounded by the sealant SE. The active area ACT has, for example, a substantially rectangular shape, and is composed of a plurality of pixels PX which are arrayed in a matrix of m×n (m and n are positive integers).

The array substrate AR includes gate lines G extending in a first direction X, source lines S extending in a second direction Y crossing the first direction X, a switching element SW which is electrically connected to the gate line G and source line S and is disposed in association with each of pixels PX, and a pixel electrode PE which is electrically connected to the switching element SW. A counter-electrode CE, which is opposed to each pixel electrode PE via the liquid crystal layer LQ, is provided, for example, on the counter-substrate CT.

Although a description of the detailed structure of the liquid crystal display panel LPN is omitted, the liquid crystal display panel LPN is configured such that a mode which mainly uses a vertical electric field, such as a TN (Twisted Nematic) mode, an OCB (Optically Compensated Bend) mode or a VA (Vertical Aligned) mode, or a mode which mainly uses a lateral electric field, such as an IPS (In-Plane Switching) mode or an FFS (Fringe Field Switching) mode, is applicable to the liquid crystal display panel LPN. In the structure in which a mode using a lateral electric field is applied, both the pixel electrode PE and counter-electrode CE are provided on the array substrate AR.

The signal supply source, such as the driving IC chip 2 and flexible wiring board 3, is located on a peripheral area PRP on the outside of the active area ACT, and is mounted on a mount portion MT of the array substrate AR, which extends outward from a substrate terminal end CTE of the counter-substrate CT.

The sealant SE is located on the peripheral area PRP between the active area ACT and end portions of the counter-substrate CT. This sealant SE has a closed-loop shape (i.e. is continuous without a break), and is formed, for example, in a substantially rectangular frame shape. Specifically, a filling port for filling a liquid crystal material is not formed in the sealant SE.

The sealant SE is formed of a sealing material such as an ultraviolet-curing resin or a thermosetting resin, and is formed by a method of continuously drawing the sealing material from a start point to an end point with use of a dispenser or the like.

Next, a manufacturing method of the above-described liquid crystal display panel LPN is described.

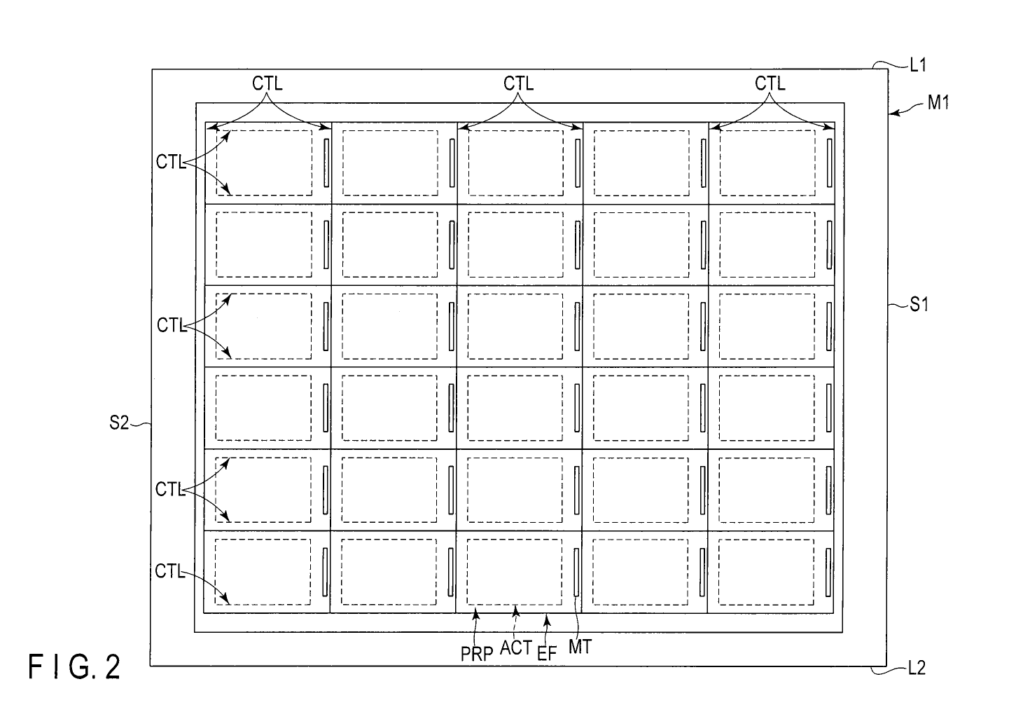

To begin with, as shown in FIG. 2, a first mother-substrate M1 for forming array substrates AR is prepared. The first mother-substrate M1 is formed by using a transparent insulative substrate such as a glass substrate. The first mother-substrate M1 has a pair of long sides L1 and L2, and a pair of short sides S1 and S2. A plurality of effective regions EF are formed on the first mother-substrate M1. Each of the effective regions EF corresponds to a region for forming the array substrate AR. The effective region EF includes an active area ACT and a peripheral area PRP. In the active area ACT, various insulation films, switching elements SW, pixel electrodes PE and an alignment film are formed. In the peripheral area PRP, for example, the mount portion MT for mounting the driving IC chip 2 and flexible wiring board 3 is formed, although the detailed depiction of these components is omitted.

In addition, “CTL” on the first mother-substrate M1, which is illustrated, denotes cutting lines for cutting the first mother-substrate M1 when array substrates AR are individually cut out of the first mother-substrate M1 in a subsequent step. Each of the effective regions EF corresponds to a region surrounded by the cutting lines CTL.

Although not illustrated, a second mother-substrate M2 for forming a counter-substrate CT is prepared, on the other hand. The second mother-substrate M2 has, for example, the same size as the first mother-substrate M1.

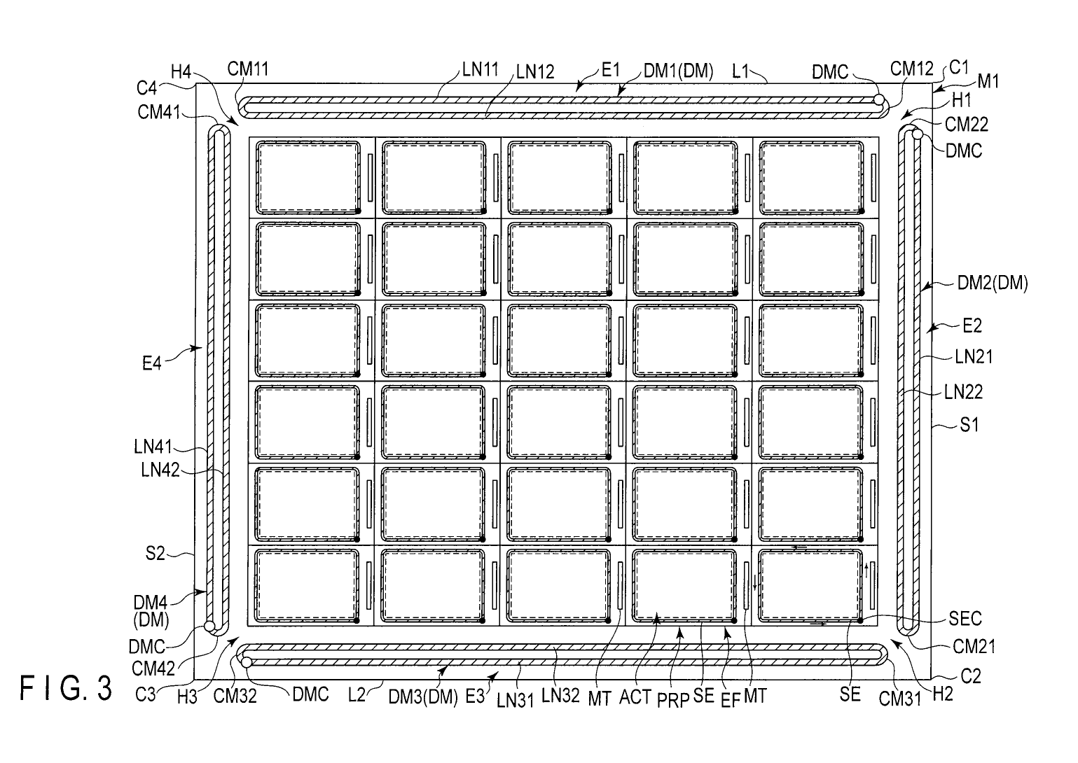

Subsequently, as illustrated in FIG. 3, a sealant SE having a closed loop shape, which surrounds each of the active area ACT of the effect region EF, is formed on the first mother-substrate M1. The sealant SE with this shape is formed by continuously drawing a sealing material such that the start point and end point thereof overlap, by using a dispenser. In the sealant SE, a position indicated by a black point in the Figure corresponds to a close portion SEC. Specifically, in the formation of the sealant SE, the drawing of the sealing material is started from a start point that is a position corresponding to the close portion SEC, and the drawing of the sealing material is continuously performed along a direction indicated by an arrow in the Figure so that the sealing material may form a substantially rectangular closed loop surrounding the active area ACT. Then, the drawing of the sealing material is terminated at an end point that is a position corresponding to the close portion SEC. In short, the position of the start point of the drawing of each sealant SE substantially agrees with the position of the end point of the drawing.

In addition, as shown in FIG. 3, dummy sealants DM are formed along a plurality of end portions of the first mother-substrate M1. Each of the dummy sealants DM is formed in a closed loop shape (endless shape) and is located on the outside of the effective region EF (or active area ACT). In the example illustrated, four dummy sealants DM1 to DM4 are formed on the first mother-substrate M1.

The dummy sealant DM1 is formed along a first end portion E1, that is, the long side L1 of the first mother-substrate M1, and extends substantially in parallel to the long side L1. The dummy sealant DM1 includes a straight portion LN11, a straight portion LN12 which is spaced apart from the straight portion LN11 and is substantially parallel to the straight portion LN11, a curved portion CM11 which connects one end portion of the straight portion LN11 and one end portion of the straight portion LN12, and a curved portion CM12 which connects the other end portion of the straight line LN11 and the other end portion of the straight line LN12. The straight portion LN11 and straight portion LN12 are linearly formed substantially in parallel to the long side L1. Each of the curved portion CM11 and curved portion CM12 is formed in a U shape. The curved portion CM11 is located near a corner C4 at which the long side L1 and the short side S2 intersect, and the curved portion CM12 is located near a corner C1 at which the long side L1 and the short side S1 intersect.

The dummy sealant DM2 is formed along a second end portion E2, that is, the short side S1 of the first mother-substrate M1, and extends substantially in parallel to the short side S1. The second end portion E2 is perpendicular to the first end portion E1. The dummy sealant DM2 includes a straight portion LN21, a straight portion LN22 which is spaced apart from the straight portion LN21 and is substantially parallel to the straight portion LN21, a curved portion CM21 which connects one end portion of the straight portion LN21 and one end portion of the straight portion LN22, and a curved portion CM22 which connects the other end portion of the straight line LN21 and the other end portion of the straight line LN22. The straight portion LN21 and straight portion LN22 are linearly formed substantially in parallel to the short side S1. Each of the curved portion CM21 and curved portion CM22 is formed in a U shape. The curved portion CM21 is located near a corner C2 at which the long side L2 and the short side S1 intersect, and the curved portion CM22 is located near the corner C1 at which the long side L1 and the short side S1 intersect.

The dummy sealant DM3 is formed along a third end portion E3, that is, the long side L2 of the first mother-substrate M1, and extends substantially in parallel to the long side L2. The third end portion E3 is parallel to the first end portion E1 and is perpendicular to the second end portion E2. The dummy sealant DM3 includes a straight portion LN31, a straight portion LN32 which is spaced apart from the straight portion LN31 and is substantially parallel to the straight portion LN31, a curved portion CM31 which connects one end portion of the straight portion LN31 and one end portion of the straight portion LN32, and a curved portion CM32 which connects the other end portion of the straight line LN31 and the other end portion of the straight line LN32. The straight portion LN31 and straight portion LN32 are linearly formed substantially in parallel to the long side L2. Each of the curved portion CM31 and curved portion CM32 is formed in a U shape. The curved portion CM31 is located near the corner C2 at which the long side L2 and the short side S1 intersect, and the curved portion CM32 is located near a corner C3 at which the long side L2 and the short side S2 intersect.

The dummy sealant DM4 is formed along a fourth end portion E4, that is, the short side S2 of the first mother-substrate M1, and extends substantially in parallel to the short side S2. The fourth end portion E4 is parallel to the second end portion E2 and is perpendicular to the first end portion E1 and third end portion E3. The dummy sealant DM4 includes a straight portion LN41, a straight portion LN42 which is spaced apart from the straight portion LN41 and is substantially parallel to the straight portion LN41, a curved portion CM41 which connects one end portion of the straight portion LN41 and one end portion of the straight portion LN42, and a curved portion CM42 which connects the other end portion of the straight line LN41 and the other end portion of the straight line LN42. The straight portion LN41 and straight portion LN42 are linearly formed substantially in parallel to the short side S2. Each of the curved portion CM41 and curved portion CM42 is formed in a U shape. The curved portion CM41 is located near the corner C4 at which the long side L1 and the short side S2 intersect, and the curved portion CM42 is located near the corner C3 at which the long side L2 and the short side S2 intersect.

Like the sealant SE, each of the dummy sealants DM1 to DM4 with the above-described shapes is formed by continuously drawing a sealing material such that the start point and end point of the drawing overlap, by using a dispenser. In each of the dummy sealants DM1 to DM4, a position indicated by a circle in the Figure is a position where the start point and end point of the drawing overlap and corresponds to a close portion DMC. For example, in the dummy sealant DM1, the drawing of a sealing material is started from a start point which is a position corresponding to the close portion DMC. From the start point, the sealing material is drawn substantially parallel to the long side L1, and the straight portion LN11 is formed. Then, the sealing material is drawn with a U-turn being made, thereby forming the curved portion CM11. The sealing material is then drawn once again in parallel to the long side L1, thereby forming the straight portion LN12. Then, with a U-turn being made, the sealing material is drawn and the curved portion CM12 is formed, and the continuous drawing of the sealing material is terminated at an end point that is a position overlapping the start point. Thereby, the dummy sealant DM1 having the closed loop shape is formed. Although not described in detail, the dummy sealants DM2 to DM4 are formed by similar drawing.

The dummy sealants DM1 to DM4 are spaced apart from each other. Specifically, one end side of the dummy sealant DM1, that is, the curved portion CM12 is spaced apart from one end side of the dummy sealant DM2, that is, the curved portion CM22. The other end side of the dummy sealant DM2, that is, the curved portion CM21 is spaced apart from other end side of the dummy sealant DM3, that is, the curved portion CM31. The one end side of the dummy sealant DM3, that is, the curved portion CM32 is spaced apart from one end side of the dummy sealant DM4, that is, the curved portion CM42. The other end side of the dummy sealant DM4, that is, the curved portion CM41 is spaced apart from the other end side of the dummy sealant DM1, that is, the curved portion CM11.

An air inlet H1 is formed between the dummy sealant DM1 and dummy sealant DM2 (i.e. between the curved portion CM12 and curved portion CM22). An air inlet H2 is formed between the dummy sealant DM2 and dummy sealant DM3 (i.e. between the curved portion CM21 and curved portion CM31). An air inlet H3 is formed between the dummy sealant DM3 and dummy sealant DM4 (i.e. between the curved portion CM32 and curved portion CM42). An air inlet H4 is formed between the dummy sealant DM4 and dummy sealant DM1 (i.e. between the curved portion CM41 and curved portion CM11).

The close portions DMC of the dummy sealants DM1 to DM4 are located near the air inlets H1 to H4, respectively. Specifically, each close portion DMC is formed at a location where a relatively wide space can be secured. Alternatively, the close portion DMC of the dummy sealant DM1 is located between the other end portion of the straight portion LN11 and the other end portion of the straight portion LN12. In the example illustrated, the close portion DMC of the dummy sealant DM1 is located near the air inlet H1 and is located between the straight portion LN11 and curved portion CM12, but the close portion DMC may be located at an intermediate part of the curved portion CM12 or may be located between the straight portion LN12 and the curved portion CM12. Similarly, the close portion DMC of the dummy sealant DM2 is located near the air inlet H1, and the close portion DMC of each of the dummy sealant DM3 and dummy sealant DM4 is located near the air inlet H3.

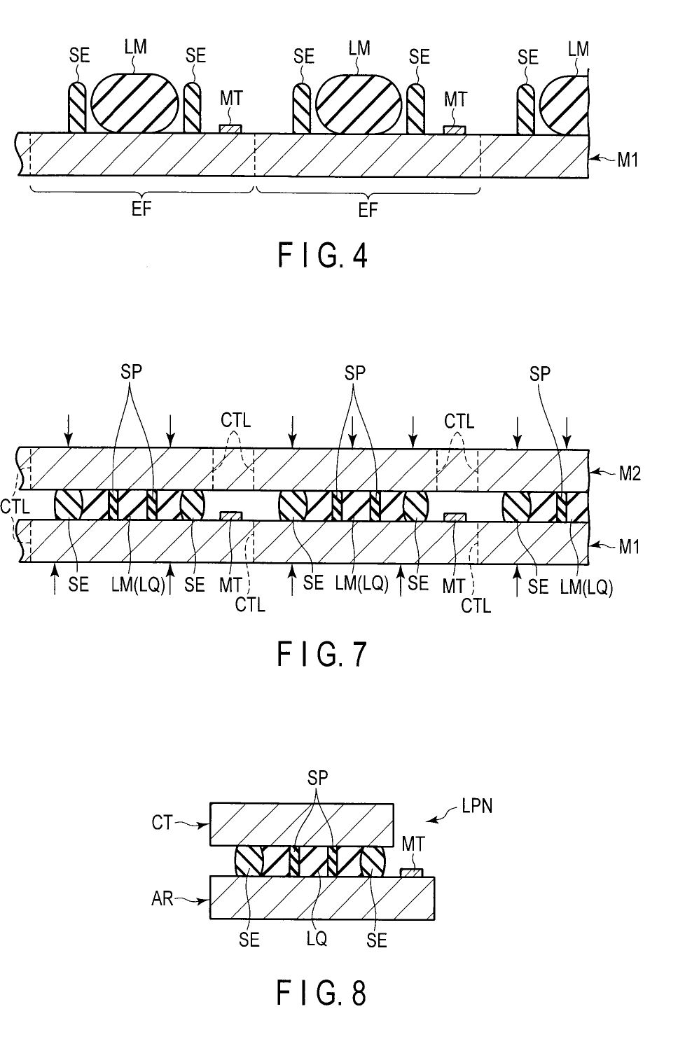

Following the above, as illustrated in FIG. 4, on the first mother-substrate M1, a liquid crystal material LM is dropped in an inside (including the active area ACT) surrounded by the sealant SE with respect to each of the effective regions EF. At this time, the liquid crystal material LM is disposed on an alignment film which is formed on the surface of each effective region EF.

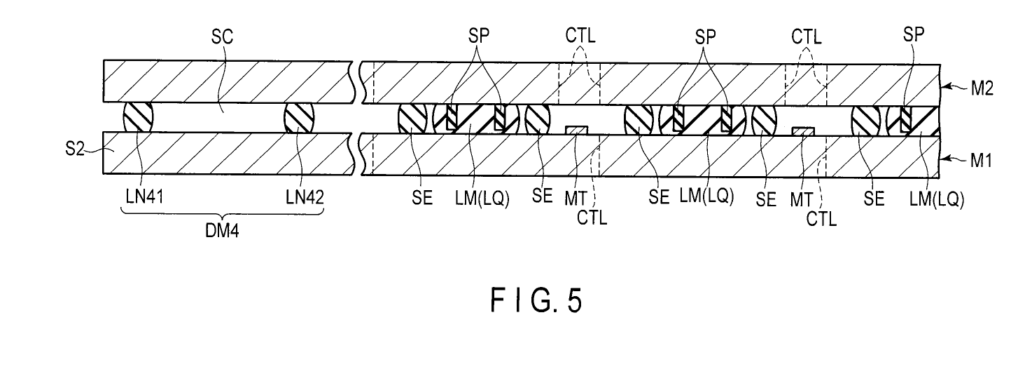

Subsequently, as illustrated in FIG. 5, the first mother-substrate M1 and second mother-substrate M2 are attached. Specifically, the first mother-substrate M1 is disposed in a pressure-reduced environment (or a vacuum environment) such as a vacuum chamber, and the second mother-substrate M2 is disposed to be opposed to each of the regions surrounded by the sealants SE and dummy sealants DM. In the example illustrated, columnar spacers are formed on the second mother-substrate M2. The columnar spacers SP may be disposed not only in the inside surrounded by each sealant SE, but also on the outside of each sealant SE or in the inside surrounded by the dummy sealants DM.

Then, by properly pressurizing the first mother-substrate M1 and second mother-substrate M2, the second mother-substrate M2 is put in contact with the sealants SE and dummy sealants DM, and the sealants SE and dummy sealants DM are collapsed between the first mother-substrate M1 and second mother-substrate M2. Thereby, the inside region surrounded by the dummy sealants DM becomes a sealed space. In the state in the example illustrated, while a liquid crystal material LM spreads in the inside region surrounded by each sealant SE, a sealed space SC is created in the inside of the dummy sealant DM4.

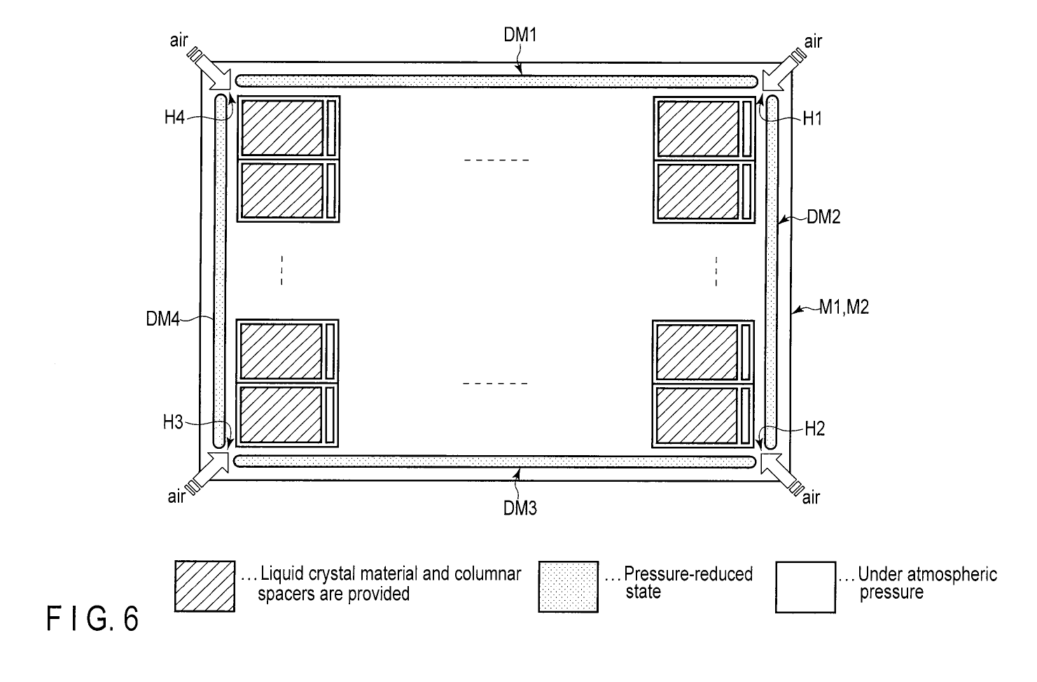

Thereafter, as illustrated in FIG. 6, by restoring the reduced-pressure environment to the atmospheric-pressure environment, the first mother-substrate M1 and second mother-substrate M2 are pressurized by the atmospheric pressure, and atmospheric air is introduced from the air inlets H1 to H4 into the space between the first mother-substrate M1 and second mother-substrate M2. In FIG. 6, areas indicated by hatching correspond to the inside regions surrounded by the sealants SE, which include the liquid crystal material and columnar spacers. Areas indicated by half-tone dots correspond to the inside regions surrounded by the dummy sealants DM, which are kept in a pressure-reduced state (or a vacuum state). Specifically, when the pressure is restored to the atmospheric pressure, the atmospheric pressure acts on the peripheries of the first mother-substrate M1 and second mother-substrate M2, while the inside regions surrounded by the sealants SE and dummy sealants DM are substantially kept in a vacuum state. Thus, a pressure difference occurs between the inside regions surrounded by the sealants SE and dummy sealants DM and the outside region. By making use of this pressure difference, the first mother-substrate M1 and second mother-substrate M2 are pressurized.

In particular, since the inside region of each of the dummy sealants DM1 to DM4 is the sealed space SC having a lower air pressure than the atmospheric pressure, the volume of the sealed space SC contracts so as to make the air pressure in the sealed space SC closer to the atmospheric pressure. Thereby, a strong pressurizing force occurs centering on the sealed space SC, so as to decrease the distance between the first mother-substrate M1 and second mother-substrate M2. At this time, since the dummy sealants DM1 to DM4 are disposed at the four sides of the first mother-substrate M1 and second mother substrate M2, a substantially equal in-plane pressure acts on the first mother-substrate M1 and second mother-substrate M2.

In the meantime, as shown in FIG. 7, when the resultant structure is opened to the atmospheric pressure, the liquid crystal material LM further spreads in the inside regions surrounded by the sealants SE, and these inside regions are properly collapsed until a desired cell gap is obtained by the columnar spacers SP.

Then, the sealants SE and dummy sealants DM are cured. In the curing process of the sealants SE and dummy sealants DM, a method, such as ultraviolet irradiation or baking under a high-temperature environment, is applied. Thereby, in each of the effective regions EF, the liquid crystal layer LQ is formed between the first mother-substrate M1 and second mother-substrate M2.

Thereafter, both the first mother-substrate M1 and second mother-substrate M2 are cut along cutting lines CTL. Thereby, as shown in FIG. 8, the array substrate AR is taken out of the first mother-substrate M1, the counter-substrate CT is taken out of the second mother-substrate M2, and the liquid crystal display panel LPN, in which the liquid crystal layer LQ is held between the array substrate AR and counter-substrate CT, is fabricated.

According to the present embodiment, each of the plural dummy sealants DM is formed in a closed loop shape between the first mother-substrate M1 and second mother-substrate M2 which are attached to each other under the pressure-reduced environment. Thus, when the environment is restored from the pressure-reduced environment to the atmospheric-pressure environment, the inside regions surrounded by the dummy sealants DM are kept in the pressure-reduced state. By the effect of the pressure difference between the inside and the outside of the dummy sealant DM, a large pressure acts on both the first mother-substrate M1 and second mother-substrate M2 in such a direction to collapse the sealants SE and dummy sealants DM. The inside regions surrounded by the sealants SE are properly collapsed until a desired cell gap is obtained. In addition, since the air inlet H is formed between the neighboring dummy sealants DM, atmospheric air is introduced from the air inlet H when the pressure is restored to the atmospheric pressure. Thus, excessive collapse of the region on the outside of the region surrounded by the sealant SE can be suppressed. Thereby, the uniformity in cell gap in each effective region EF can be improved. Therefore, degradation in display quality due to non-uniformity in cell gap can be suppressed, and the manufacturing yield can be improved.

In addition, the air inlet H is formed between the U-shaped curved portions of the neighboring dummy sealants DM. Thus, compared to the case in which an air inlet H is formed at an intermediate part of the straight portion of the dummy sealant, it is possible to suppress the occurrence of such a disadvantage that the air inlet H is locally narrowed and the introduction of atmospheric air is hindered.

The close portion DMC of the dummy sealant DM, which is formed by drawing the sealing material in the closed loop shape, is located at an intermediate part of the curved portion or at a part between the straight portion and the curved portion. Specifically, the close portion DMC is formed near the air inlet H or at a location where a relatively wide space can be secured. Thus, when the dummy sealant DM is collapsed, the line width of the close portion DMC becomes locally greater than the line width of the part at the other location (the straight portion or curved portion), but the spreading to the effective region EF can be suppressed. Therefore, the effective regions EF can be allocated up to the end portions of the first mother-substrate M1, and the manufacturing yield can be enhanced.

Besides, the dummy sealants DM are located, respectively, at the four sides of the first mother-substrate M1 and second mother-substrate M2. Thus, when the pressure is restored to the atmospheric pressure, the first mother-substrate M1 and second mother-substrate M2 are pressurized by a substantially uniform in-plane pressure. Thereby, the uniformity of the cell gap is further enhanced.

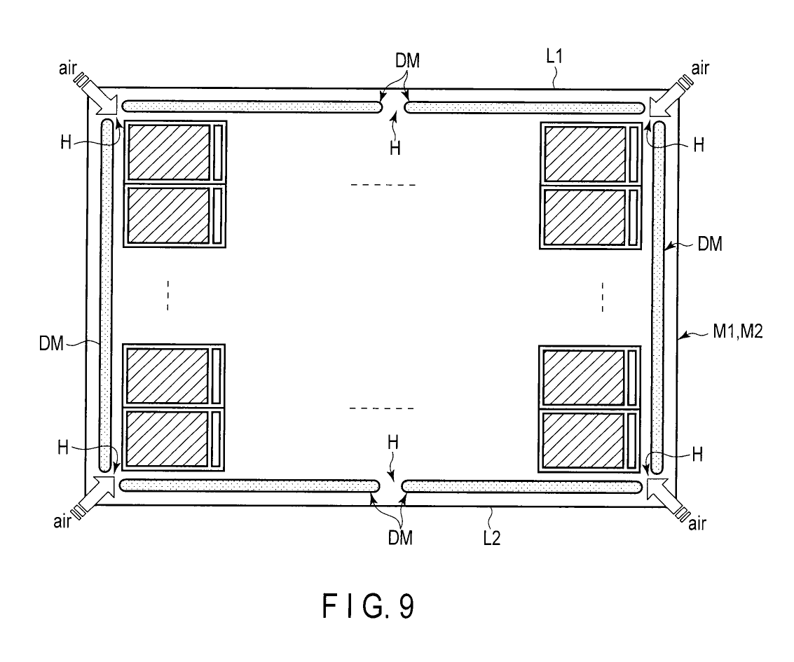

The shapes of the dummy sealants DM or the locations of the air inlets H are not limited to the example shown in FIG. 3. For example, as shown in FIG. 9, a plurality of dummy sealants DM each having a closed loop shape may be disposed to be arranged along each of the long sides L1 and L2 of the first mother-substrate M1. Specifically, the plural dummy sealants DM are linearly arranged in parallel to the long sides L1 and L2, and an air inlet H is formed between the dummy sealants DM. In this manner, as regards each dummy sealant DM, by forming each dummy sealant DM with a relatively small length, it becomes possible to prevent breakage of the sealing material while the dummy sealant DM is being formed.

As has been described above, according to the present embodiment, it is possible to provide a manufacturing method of a liquid crystal display device which can improve the uniformity of the cell gap.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A manufacturing method of a liquid crystal display device, comprising:
forming sealants each having a closed loop shape surrounding each of a plurality of active areas on a first substrate;
forming dummy sealants each located on an outside of the plurality of active areas and having a closed loop shape at a plurality of end portions of the first substrate, said forming the dummy sealants including forming a first straight portion from a first start point and then, with a U-turn being made, forming a second straight portion which is spaced apart from the first straight portion and is parallel to the first straight portion, thereby forming a first dummy sealant having a first end point overlapping the first start point, and forming a third straight portion from a second start point and then, with a U-turn being made, forming a fourth straight portion which is spaced apart from the third straight portion and is parallel to the third straight portion, thereby forming a second dummy sealant having a second end point overlapping the second start point, and forming a first air inlet between the first dummy sealant and the second dummy sealant;
dropping a liquid crystal material in an inside surrounded by each of the sealants; and
disposing a second substrate such that the second substrate is opposed to each of regions surrounded by the sealants and the dummy sealants of the first substrate in a pressure-reduced environment, and subsequently pressurizing the first substrate and the second substrate by an atmospheric pressure, introducing atmospheric air from the first air inlet into a space between the first substrate and the second substrate, and curing the sealants and the dummy sealants.

2. The manufacturing method of claim 1, wherein the first air inlet is formed between a first curved portion with a U shape of the first dummy sealant and a second curved portion with a U shape of the second dummy sealant.

3. The manufacturing method of claim 1, wherein said forming the dummy sealants includes forming a third dummy sealant which neighbors the second dummy sealant and forms a second air inlet between the third dummy sealant and the second dummy sealant, and forming a fourth dummy sealant which neighbors the third dummy sealant, forms a third air inlet between the fourth dummy sealant and the third dummy sealant, neighbors the first dummy sealant and forms a fourth air inlet between the fourth dummy sealant and the first dummy sealant.

4. A manufacturing method of a liquid crystal display device, comprising:
forming sealants each having a closed loop shape surrounding each of a plurality of active areas on a first substrate;
forming dummy sealants each located on an outside of the plurality of active areas and having a closed loop shape at a plurality of end portions of the first substrate, said forming the dummy sealants including forming a first dummy sealant including a first straight portion, a second straight portion which is spaced apart from the first straight portion and is parallel to the first straight portion, a first curved portion connecting one end portion of the first straight portion and one end portion of the second straight portion, and a second curved portion connecting the other end portion of the first straight portion and the other end portion of the second straight portion, and forming a second dummy sealant including a third straight portion, a fourth straight portion which is spaced apart from the third straight portion and is parallel to the third straight portion, a third curved portion connecting one end portion of the third straight portion and one end portion of the fourth straight portion, and a fourth curved portion connecting the other end portion of the third straight portion and the other end portion of the fourth straight portion, and forming a first air inlet between the second curved portion and the third curved portion;
dropping a liquid crystal material in an inside surrounded by each of the sealants; and
disposing a second substrate such that the second substrate is opposed to each of regions surrounded by the sealants and the dummy sealants of the first substrate in a pressure-reduced environment, and subsequently pressurizing the first substrate and the second substrate by an atmospheric pressure, introducing atmospheric air from the first air inlet into a space between the first substrate and the second substrate, and curing the sealants and the dummy sealants.

5. The manufacturing method of claim 4, wherein the first dummy sealant is drawn such that a first start point and a first end point overlap, the first start point and the first end point being located between the other end portion of the first straight portion and the other end portion of the second straight portion.

6. The manufacturing method of claim 4, wherein said forming the dummy sealants includes forming a third dummy sealant including a fifth straight portion, a sixth straight portion which is spaced apart from the fifth straight portion and is parallel to the fifth straight portion, a fifth curved portion connecting one end portion of the fifth straight portion and one end portion of the sixth straight portion, and a sixth curved portion connecting the other end portion of the fifth straight portion and the other end portion of the sixth straight portion, and forming a fourth dummy sealant including a seventh straight portion, an eighth straight portion which is spaced apart from the seventh straight portion and is parallel to the seventh straight portion, a seventh curved portion connecting one end portion of the seventh straight portion and one end portion of the eighth straight portion, and an eighth curved portion connecting the other end portion of the seventh straight portion and the other end portion of the eighth straight portion; and
forming a second air inlet between the fourth curved portion and the fifth curved portion, forming a third air inlet between the sixth curved portion and the seventh curved portion, and forming a fourth air inlet between the first curved portion and the eighth curved portion.

7. A manufacturing method of a liquid crystal display device, comprising:
forming sealants each having a closed loop shape on a first substrate;
forming dummy sealants each having a closed loop shape at a plurality of end portions of the first substrate, said forming the dummy sealants including forming at a first end portion a first dummy sealant including a first straight portion, a second straight portion which is spaced apart from the first straight portion and is parallel to the first straight portion, a first curved portion connecting one end portion of the first straight portion and one end portion of the second straight portion, and a second curved portion connecting the other end portion of the first straight portion and the other end portion of the second straight portion, and forming at a second end portion, which is perpendicular to the first end portion, a second dummy sealant including a third straight portion, a fourth straight portion which is spaced apart from the third straight portion and is parallel to the third straight portion, a third curved portion connecting one end portion of the third straight portion and one end portion of the fourth straight portion, and a fourth curved portion connecting the other end portion of the third straight portion and the other end portion of the fourth straight portion, the second dummy sealant being spaced apart from the first dummy sealant;
dropping a liquid crystal material in an inside surrounded by each of the sealants; and
disposing a second substrate such that the second substrate is opposed to each of regions surrounded by the sealants and the dummy sealants of the first substrate in a pressure-reduced environment, and subsequently pressurizing the first substrate and the second substrate by an atmospheric pressure, introducing atmospheric air into a space between the first substrate and the second substrate, and curing the sealants and the dummy sealants.

8. The manufacturing method of claim 7, wherein the first dummy sealant is drawn such that a first start point and a first end point overlap, the first start point and the first end point being located between the other end portion of the first straight portion and the other end portion of the second straight portion.

9. The manufacturing method of claim 7, wherein said forming the dummy sealants includes forming at a third end portion, which is parallel to the first end portion, a third dummy sealant including a fifth straight portion, a sixth straight portion which is spaced apart from the fifth straight portion and is parallel to the fifth straight portion, a fifth curved portion connecting one end portion of the fifth straight portion and one end portion of the sixth straight portion, and a sixth curved portion connecting the other end portion of the fifth straight portion and the other end portion of the sixth straight portion, the third dummy sealant being spaced apart from the first dummy sealant and the second dummy sealant; and
forming at a fourth end portion, which is parallel to the second end portion, a fourth dummy sealant including a seventh straight portion, an eighth straight portion which is spaced apart from the seventh straight portion and is parallel to the seventh straight portion, a seventh curved portion connecting one end portion of the seventh straight portion and one end portion of the eighth straight portion, and an eighth curved portion connecting the other end portion of the seventh straight portion and the other end portion of the eighth straight portion, the fourth dummy sealant being spaced apart from the first, second and third dummy sealants.
